(19) United States
(12) Patent Application Publication
(10) Pub. No.: US 2012/0188234 A1
(43) Pub. Date: Jul. 26, 2012

(54) IMAGE PROCESSING APPARATUS AND METHOD

(75) Inventors: Antonio ORTEGA, Los Angeles, CA (US); Woo-Shik Kim, Los Angeles, CA (US); Jae Joon Lee, Seoul (KR); Ho Cheon Wey, Seongnam Si (KR)

(73) Assignees: University of Southern California, Los Angeles, CA (US); Samsung Electronics Co., Ltd., Suwon-si (KR)

(21) Appl. No.: 13/352,774

(22) Filed: Jan. 18, 2012

Related U.S. Application Data
(60) Provisional application No. 61/434,576, filed on Jan. 20, 2011.

(30) Foreign Application Priority Data
Feb. 11, 2011 (KR) 10-2011-0012506

(51) Int. Cl. G06T 15/00

(52) U.S. Cl. 345/419

(57) ABSTRACT

Provided is an image processing apparatus. The image processing apparatus may synthesize an image observed at a target view excluding a reference view. A decoder of the image processing apparatus may decode depth transition data. A first map generator of the image processing apparatus may generate a foreground and background map of a target view to render an image, based on the decoded depth transition data. A rendering unit of the image processing apparatus may determine a color value of each of pixels constituting the image by comparing the foreground and background map of the target view with a foreground and background map of at least one reference view.

### CROSS-REFERENCE TO RELATED APPLICATIONS

This application claims the priority benefit of U.S. Provisional Patent Application No. 61/434,576, filed on Jan. 20, 2011 in the USPTO and Korean Patent Application No. 10-2011-0012506, filed on Feb. 11, 2011, in the Korean Intellectual Property Office, the disclosures of which are incorporated herein by reference.

### BACKGROUND

1. Field

Example embodiments relate to an image processing apparatus and method to provide a three-dimensional (3D) image, and more particularly, to an apparatus and method to synthesize a predetermined target view image in a stereoscopic display or an autostereoscopic 3D display.

2. Description of the Related Art

A glass type stereoscopic display being generally applied in a three-dimensional (3D) image service has inconvenience of wearing glasses and also has many constraints, for example, a constraint in a view region occurring due to use of only a single pair of left and right images, a motion parallax, and the like.

Research on a multi-view display enabling a configuration at multiple views with using a plurality of images and without using glasses has been actively conducted. In addition, standardization on compression and a format for a multi-view image, for example, motion picture experts group (MPEG) 3DV and the like has been ongoing.

In the above multi-view image scheme, images observed from a plurality of views may need to be transmitted. A method of transmitting the whole 3D images observed from all the views may use a significantly great bandwidth and thus, may not be realized.

Accordingly, there is a desire for a method that may transmit a predetermined number of view images and side information, for example, depth information and/or disparity information, and may generate and display a plurality of view images used by a reception apparatus.

### SUMMARY

The foregoing and/or other aspects are achieved by providing an image processing apparatus, including: a decoder to decode depth transition data; a first map generator to generate a foreground and background map of a target view to render an image, based on the decoded depth transition data; and a rendering unit to determine a color value of each of pixels constituting the image by comparing the foreground and background map of the target view with a foreground and background map of at least one reference view.

The depth transition data may include information associated with a view at which a foreground-to-background transition or a background-to-foreground transmission occurs for each pixel.

The first map generator may generate the foreground and background map of the target view by comparing the target view with a transition view between a background and a foreground of each pixel included in the decoded depth transition data, and by determining whether each pixel corresponds to the foreground or the background at the target view.

The image processing apparatus may further include a second map generator to generate a foreground and background map of each of the at least one reference view based on depth information of each of the at least one reference view.

The second map generator may generate the foreground and background map of each of the at least one reference view by k-mean clustering depth information of each of the at least one reference view.

The second map generator may generate the foreground and background map of each of the at least one reference view by clustering depth information of each of the at least one reference view, and by performing histogram equalizing.

The rendering unit may include: a comparator to determine whether a foreground and background map value of a first pixel among a plurality of pixels constituting a target view image matches foreground and background map values of pixels having the same index as the first pixel within an image of each of the at least one reference view; a selector to select, as a valid reference view, at least one reference view having the matching foreground and background map value as the determination result; and a color determination unit to determine a color value of the first pixel using an image of the valid reference view.

When a number of valid reference views is at least two, the color determination unit may determine the color value of the first pixel by blending color values of the at least two valid reference views. When the number of valid reference views is one, the color determination unit may determine the color value of the first pixel by copying a color value of the single valid reference view. When the number of valid reference views is zero, the color determination unit may determine the color value of the first pixel by performing hole filling using rendered color values of pixels adjacent to the first pixel.

The blending may correspond to a weighted summation process of applying, to a color value of each valid reference view, a weight that is in inverse proportion to a distance from the target view and by summing up the application results.

The foregoing and/or other aspects are achieved by providing an image processing method, including: decoding depth transition data; generating a foreground and background map of a target view to render an image, based on the decoded depth transition data; and determining a color value of each of pixels constituting the image by comparing the foreground and background map of the target view with a foreground and background map of at least one reference view.

The example embodiments may include an image processing apparatus and method that may quickly generate a target view image with a high quality by applying depth transition data for a synthesis process when generating the target view image.

The example embodiments may also include an image processing apparatus and method that may minimize an eroded region during an image synthesis process of a predetermined target view and may synthesize an image with a high reality.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates an image processing apparatus according to example embodiments;

FIG. 2 illustrates a configuration of a rendering unit of the image processing apparatus of FIG. 1;

FIG. 3 illustrates a three-dimensional (3D) object observed at each view to describe depth transition data received according to example embodiments;

FIG. 4 illustrates a graph showing a depth level of the 3D object of FIG. 3 with respect to coordinates (10, 10) according to example embodiments;

FIG. 5 illustrates depth transition data received according to example embodiments;

FIG. 6 illustrates a diagram to describe an image processing method according to example embodiments;

FIG. 7 illustrates an image processing method according to example embodiments;

FIG. 8 illustrates an operation of calculating a color value of an i^{th} pixel in the image processing method of FIG. 8; and

FIG. 9 illustrates images to describe an image processing method according to example embodiments.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

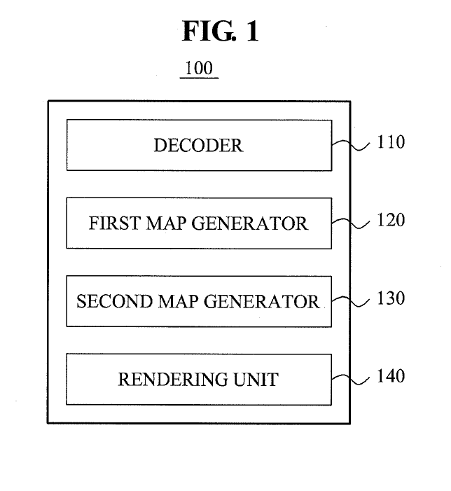

FIG. 1 illustrates an image processing apparatus 100 according to example embodiments.

Images corresponding to a plurality of reference views may be input into the image processing apparatus 100. For example, when a multi-view image providing nine views is transferred, images corresponding to nine reference views may be input into the image processing apparatus 100.

Each of reference view images corresponding to the plurality of reference views input into the image processing apparatus 100 may include a single pair of a color image and a depth image. The above format may be referred to as a multiple video and depth (MVD) three-dimensional (3D) video format.

In this example, the image processing apparatus 100 may synthesize an image observed at a predetermined target view between the reference views as well as images observed at the reference views, and may provide the synthesized image to a user.

A decoder 110 of the image processing apparatus 100 may decode encoded depth transition data that is received together with the plurality of reference view images.

The decoding process may include any example embodiment associated with a conventional encoding and decoding method and thus, is not limited to or restricted by some encoding and decoding methods.

A first map generator 120 may generate a foreground and background map observed at the target view, based on the decoded depth transition data.

A second map generator 130 may generate a foreground and background map of each of the plurality of reference views, using depth information of each of the plurality of reference views, for example, depth images.

According to an aspect, while the second map generator 130 generates the foreground and background map with respect to each of the reference views, a process of clustering a depth level of a depth image of a corresponding reference view to two or more levels may be performed.

For example, clustering according to a k-mean average method, histogram equalizing, and the like may be employed.

According to another aspect, the second map generator 130 may generate the foreground and background map of each of the plurality of reference views based on the decoded depth transition data. Instead of generating the foreground and background map using a depth image of each reference view, or together with generating the foreground and background map using the depth image of each reference view, the second map generator 130 may generate the foreground and background map of each reference view based on only the decoded depth transition data.

A rendering unit 140 may compare the foreground and background map of the reference view with the foreground and background map of each of the plurality of reference views. The rendering unit 140 may select, for each pixel, valid reference views available to generate a color value of the target view.

A valid reference view may correspond to a reference view having the same matching result as the target view regarding whether a corresponding pixel corresponds to a foreground or a background, among the plurality of reference views. The valid reference view may be different for each pixel.

For example, to synthesize a color value of a first pixel among a plurality of pixels constituting a target view image desired to be rendered, valid pixel values available for synthesizing the color value of the first pixel may need to be selected.

In this example, the rendering unit 140 may select a predetermined number of reference views, that is, a number of valid reference views having the same foreground and background map value as a foreground and background map value of the target view with respect to the first pixel, and may synthesize the color value of the first pixel by employing a different map based on the number of selected valid reference views.

When a single valid reference view is selected, the rendering unit 140 may copy a color value of the valid reference view and determine the copied color value of the valid reference view as the color value of the first pixel.

When at least two reference views are selected, the rendering unit 140 may determine, as the color value of the first pixel, a weighted summation obtained by applying a predetermined weight to a color value of each of the at least two valid reference views and by summing up the application results.

Here, the weight may be determined based on a distance between the target view and a corresponding valid reference view. As a distance between views increases, a relatively small weight may be applied.

When a number of selected valid reference views is zero, that is, when foreground and background maps of all the remaining reference views excluding the target view do not match the foreground and background map of the target view, the first pixel may be determined as a hole and the color value of the first pixel may be determined according to a hole filling method and like after color values of pixels adjacent to the first pixel are determined. The hole filling method may be based on a general image processing method.

Hereinafter, an operation of the image processing apparatus 100 will be further described.

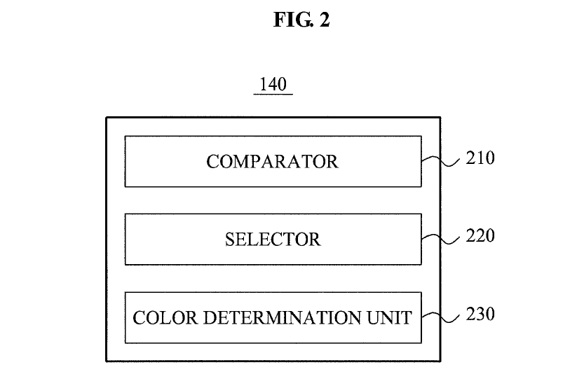

FIG. 2 illustrates a configuration of the rendering unit 140 of the image processing apparatus 100 of FIG. 1.

Referring to FIG. 2, the rendering unit 140 may include a comparator 210, a selector 220, and a color determination unit 230.

When the first map generator 110 of the image processing apparatus 100 generates a foreground and background map of a target view based on decoded depth transition data, and the second map generator 120 generates a foreground and background map of each of a plurality of reference views using depth images and/or color images of the plurality of reference views, the comparator 210 may compare the foreground and background map of the target view with the foreground and background map of each of the plurality of reference views.

The foreground and background map may be a binary map including information regarding whether a corresponding pixel corresponds to a foreground region or a background region at a corresponding view, based on a pixel unit.

However, the binary map is only an example and thus, the foreground and background map may be a map including a larger number of bits than the binary map in which the background region is divided into at least two levels for each pixel.

Accordingly, a case where the foreground and background map corresponds to the binary map, for example, the binary map in which the foreground region is 0 and the background region is 1 or vice versa will be described as an example.

The comparator 210 may compare the foreground and background map of the target view with the foreground and background map of each of the plurality of reference views, based on a pixel unit.

The selector 220 may select, for each pixel, reference views having the same foreground and background map value as the foreground and background map value of the target view, that is, reference views having the same matching result regarding whether a corresponding pixel corresponds to the foreground region or the background region. The selected reference views may correspond to valid reference views.

A number of valid reference views may be different for each pixel. For example, three valid reference views, view number 1, view number 2, and view number 3, may be selected for the first pixel, two valid reference views, view number 3 and view number 4, may be selected for a second pixel, and only a single valid reference view may be selected for a third pixel.

In addition, a case where a predetermined pixel observed at the target view corresponds to the foreground region and the same position pixel observed at remaining all the reference views corresponds to the background region, that is, a case where no reference view has a matching result with the target view regarding whether a corresponding pixel corresponds to a foreground or a background, the number of valid reference views may be determined as zero.

In this case, it may be understood that an error of the foreground and background map value of the target view is present with respect to the predetermined pixel. Due to other reasons, the above case may be inappropriate to synthesize a color value of the predetermined pixel using color values of neighboring views.

Accordingly, when the number of valid reference views is zero, the color determination unit 230 may determine the predetermined pixel as a hole. When a color value is determined with respect to other pixels, the color determination unit 230 may indirectly determine the color value of the predetermined pixel according to the hole filling method using the determined color values of the other pixels.

When a single valid reference view is present for the third pixel as in the above example, the color determination unit 230 may determine a color value of the third pixel by copying a color value of the selected valid reference view. The above process may correspond to a copy process.

When at least two valid reference views are present for the first pixel or for the second pixel as in the above example, the color determination unit 230 may determine a color value of a corresponding pixel based on a weighted summation obtained by applying a weight to a color value of each valid reference view based on a distance between views, and by summing up the application results. The above process may correspond to a blending process.

As described above with reference to FIG. 1, a relatively great weight may be applied to a valid reference view having a relatively small distance from the target view.

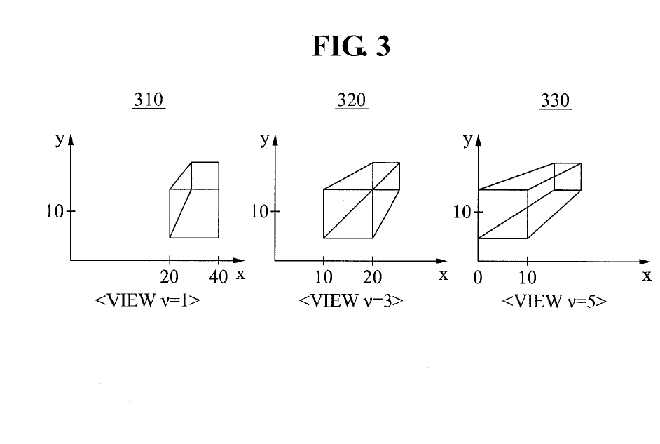

FIG. 3 illustrates a 3D object observed at each view to describe depth transition data received according to example embodiments.

Referring to FIG. 3, a view image 310, a view image 320, and a view image 330 correspond to examples of coordinates of the same cube captured at horizontally difference views v=1, v=3, and v=5, respectively.

In each of the view images 310, 320, and 330, each of an axis x and an axis y denotes a pixel index in an image.

As shown in FIG. 3, according to an increase in a view number while a view moves from left to right, disparity may occur. Accordingly, the cube may appear as if the cube has moved from right to left.

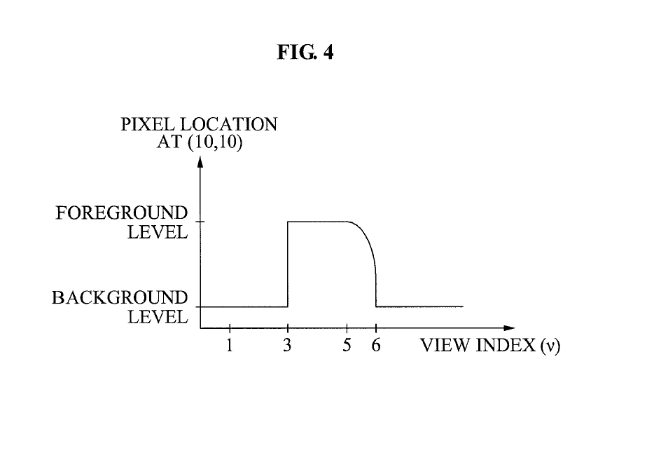

FIG. 4 illustrates a graph showing a depth level of the 3D object of FIG. 3 with respect to coordinates (10, 10) according to example embodiments.

A horizontal axis denotes a view index and a vertical axis denotes a depth level.

Referring to FIG. 4, a pixel positioned at coordinates (10, 10) may correspond to a background of the cube from view index 1 to view index 3, correspond to a foreground of the cube from the view index 3 to view index 6, and correspond to the background of the cube after the view index 6.

Depth transition data used in the present specification may include an index of a view in which a foreground-to-background transition and/or a foreground-to-background transition occurs through a depth level analysis with respect to each pixel.

For example, referring to FIG. 4, in the case of the pixel positioned at (10, 10), the background-to-foreground transition has occurred at the view index 3 and the foreground-to-background transition has occurred at the view index 6.

The depth transition data may include an index of a view in which a view transition occurs with respect to the whole pixels including the pixel positioned at (10, 10).

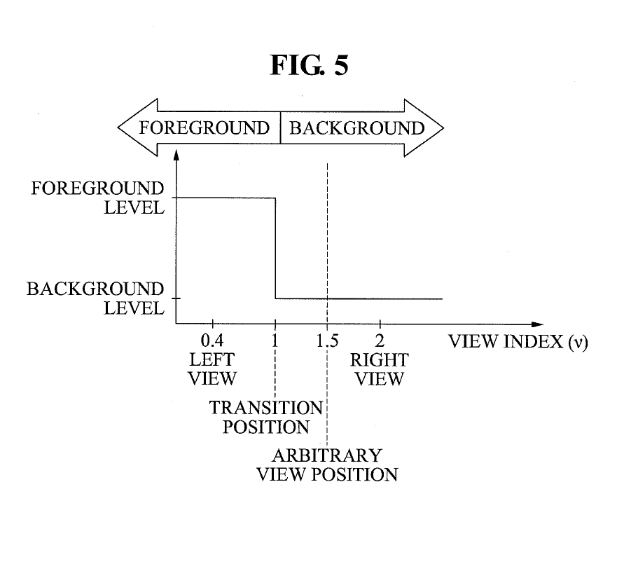

FIG. 5 illustrates depth transition data received according to example embodiments.

As described above with reference to FIG. 4, the depth transition data may include information associated with an index of a view in which a transition between a background and a foreground occurs with respect to each pixel.

As shown in FIG. 5, the index of the view in which the above view transition occurs may be a predetermined rational number, instead of a quantized integer.

In a graph of FIG. 5, a horizontal axis denotes a view index and a vertical axis denotes a depth level including a foreground level and a background level.

The graph of FIG. 5 shows a change in depth information in the case of a view transition with respect to a predetermined single pixel.

In this example, two quantized view indices of a left view and a right view may be present, and the depth level may be understood to be simplified through clustering.

Referring to the graph of FIG. 5, a foreground-to-background transition has occurred at “transition position”. When a view index of the left view is 0.4 and a view index of the right view is 2, a view index of the “transition position” may be 1.

When the image processing apparatus 100 synthesizes an image observed at an arbitrary view position of which a view index is 1.5, the view index 1.5 of the arbitrary view position in a corresponding pixel is greater than the view index 1 of the “transition position” in which the foreground-to-background transition has occurred. Accordingly, the corresponding pixel may be determined to correspond to a background region at the arbitrary view position with the view index 1.5.

The decoder 110 may perform the aforementioned process with respect to the whole pixels using decoded depth transition data, and may thereby generate the foreground and background map of the target view including information regarding whether a corresponding pixel corresponds to a background or a foreground with respect to the whole pixels of the target view.

The second map generator 130 may generate the foreground and background map with respect to each of reference views, based on depth information of each of the reference views.

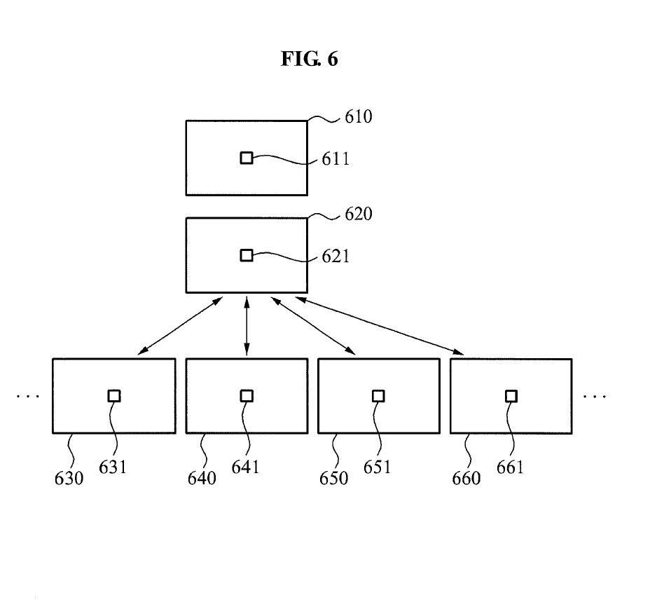

FIG. 6 illustrates a diagram to describe an image processing method according to example embodiments.

The first map generator 120 may generate a foreground and background map 620 of a target view using decoded depth transition data 610.

In a pixel 621, the first map generator 120 indicates, as binary data, information regarding whether a first pixel 611 included in the depth transition data 610 corresponds to a foreground region or a background region, with reference to a depth transition view index of the first pixel 611. The above process is described above with reference to FIG. 5.

The second map generator 130 may generate foreground and background maps 630, 640, 650, 660, and like, corresponding to reference views.

The comparator 210 included in the rendering unit 140 may compare the foreground and background map 620 of the target view with each of the foreground and background maps 630, 640, 650, 660, and like, of the reference views for each pixel.

Specifically, the comparator 210 may compare a value of the pixel 621 of the foreground and background map 620 with a value of a pixel 631 of the foreground and background map 630. The same process may be applied with respect to pixels 641, 651, 661, and like.

The selector 220 may determine, as valid reference views with respect to the pixel 621, views including pixels having the same value as the value of the pixel 621.

The color determination unit 230 may determine a color value of a target view pixel at a position of the pixel 621 by applying one of blending, copy, and hole-filling based on a number of valid reference views. The above process is described above with reference to FIG. 1 and FIG. 2.

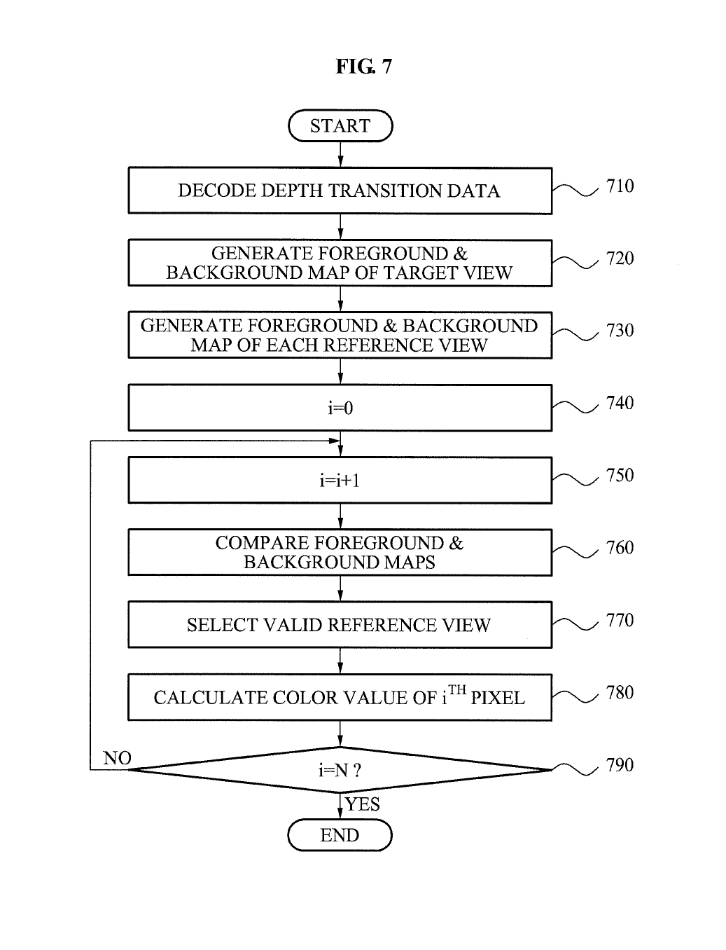

FIG. 7 illustrates an image processing method according to example embodiments.

In operation 710, the decoder 110 of the image processing apparatus 100 may decode received depth transition data.

In operation 720, the first map generator 120 may generate a foreground and background map of a target view. The above process is described above with reference to FIG. 1 and FIG. 5.

In operation 730, the second map generator 130 may generate a foreground and background map of each of reference views based on a depth image of each of the reference views. Detailed description related thereto is described above with reference to FIG. 5 and FIG. 6.

When the foreground and background maps of the target view and the reference views are generated, image rendering of the target view may be performed by the rendering unit 140 through operations 740 through 790.

In operation 740, an initial value of a pixel index i may be given. In operation 750, i may increase by ‘1’. A rendering process with respect to an i^{th} pixel of the target view may be iterated. Operations 750 through 790 corresponding to the above process may be iterated N times corresponding to a total number of pixels of a target view image desired to be rendered. Here, N denotes a natural number.

In operation 760, the comparator 210 may compare the foreground and background map of the target view with the foreground and background map of each of the reference views for each pixel.

In operation 770, the selector 220 may select, as valid reference views, reference views having the same foreground and background map value as the foreground and background map value of the target view, that is, reference views having the same matching result as the target view regarding whether a corresponding pixel corresponds to a foreground or a background.

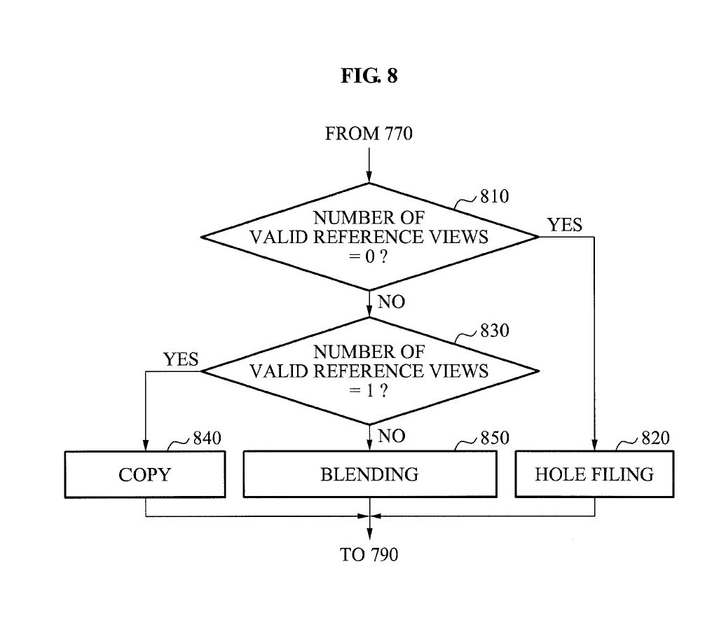

In operation 780, the color determination unit 230 may determine a color value of the i^{th} pixel among N pixels constituting a target view image, according to one of blending, copy, and hole-filling. Operation 780 will be further described with reference to FIG. 8.

FIG. 8 illustrates an operation of calculating the color value of the i^{th} pixel in the image processing method of FIG. 8.

When the number of valid reference views with respect to the predetermined pixel is determined in operation 770, the color determination unit 230 may determine whether the number of valid reference views=‘0’ in operation 810.

When the number of valid reference views=‘0’, the color determination unit 230 may determine the predetermined pixel as a hole. When color values are determined with respect to other pixels adjacent to the predetermined pixel, the color determination unit 230 may indirectly determine a color value of the predetermined pixel according to the hole-filling method based on the determined color values of the adjacent pixels.

When the number of valid reference views≠‘0’, the color determination unit 230 may determine whether the number of valid reference views=‘1’ in operation 830.

When the number of valid reference views=‘1’, the color determination unit 230 may determine the color value of the corresponding pixel by copying a color of the valid reference view in operation 840, which may correspond to a copy process.

When the number of valid reference views≠‘1’, the number of valid reference views may be two or more. Accordingly, in operation 850, the color determination unit 230 may determine the color value of the corresponding pixel based on a weighted summation obtained by applying a weight to a color value of each of the valid reference views based on a distance between views, and by summing up the application results. The above process may correspond to a blending process.

The above process is described above with reference to FIG. 2.

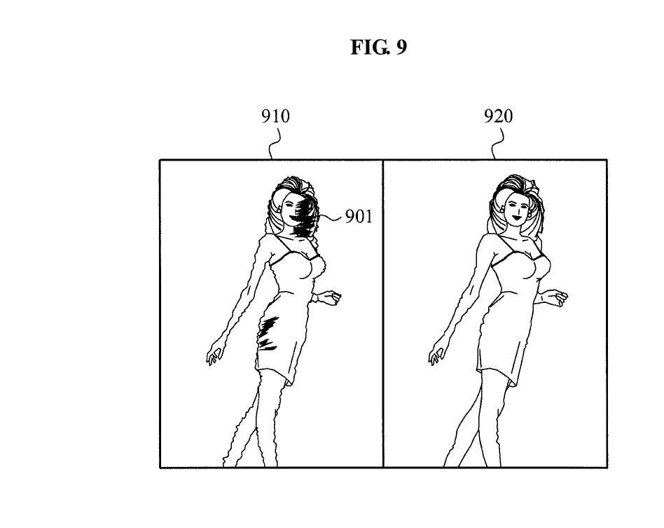

FIG. 9 illustrates images 910 and 920 to describe an image processing method according to example embodiments.

According to the example embodiments described above with reference to FIG. 1 through FIG. 8, a result 920 shows that an eroded region 901 observed in a conventional target image synthesis result 910 or a distortion phenomenon occurring in an edge portion is significantly reduced.

According to example embodiments, depth transition data may be used to a foreground and background map of a target view during synthesis of a target view image.

Accordingly, the target view image with a high quality may be quickly and readily generated, which may be significantly helpful in providing of a multi-view 3D image and in saving bandwidth of data transmission.

The image processing method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. An image processing apparatus, comprising:
a decoder to decode depth transition data;
a first map generator to generate a foreground and background map of a target view to render an image, based on the decoded depth transition data; and
a rendering unit to determine a color value of each of pixels constituting the image by comparing the foreground and background map of the target view with a foreground and background map of at least one reference view.

2. The image processing apparatus of claim 1, wherein the depth transition data comprises information associated with a view at which a foreground-to-background transition or a background-to-foreground transmission occurs for each pixel.

3. The image processing apparatus of claim 1, wherein the first map generator generates the foreground and background map of the target view by comparing the target view with a transition view between a background and a foreground of each pixel included in the decoded depth transition data, and by determining whether each pixel corresponds to the foreground or the background at the target view.

4. The image processing apparatus of claim 1, further comprising:
a second map generator to generate a foreground and background map of each of the at least one reference view based on depth information of each of the at least one reference view.

5. The image processing apparatus of claim 4, wherein the second map generator generates the foreground and background map of each of the at least one reference view by k-mean clustering depth information of each of the at least one reference view.

6. The image processing apparatus of claim 4, wherein the second map generator generates the foreground and background map of each of the at least one reference view by clustering depth information of each of the at least one reference view, and by performing histogram equalizing.

7. The image processing apparatus of claim 1, wherein the rendering unit comprises:
a comparator to determine whether a foreground and background map value of a first pixel among a plurality of pixels constituting a target view image matches foreground and background map values of pixels having the same index as the first pixel within an image of each of the at least one reference view;
a selector to select, as a valid reference view, at least one reference view having the matching foreground and background map value as the determination result; and
a color determination unit to determine a color value of the first pixel using an image of the valid reference view.

8. The image processing apparatus of claim 7, wherein:
when a number of valid reference views is at least two, the color determination unit determines the color value of the first pixel by blending color values of the at least two valid reference views,
when the number of valid reference views is one, the color determination unit determines the color value of the first pixel by copying a color value of the single valid reference view, and
when the number of valid reference views is zero, the color determination unit determines the color value of the first pixel by performing hole filling using rendered color values of pixels adjacent to the first pixel.

9. The image processing apparatus of claim 8, wherein the blending corresponds to a weighted summation process of applying, to a color value of each valid reference view, a weight that is in inverse proportion to a distance from the target view and by summing up the application results.

10. An image processing method, comprising:
decoding depth transition data;
generating a foreground and background map of a target view to render an image, based on the decoded depth transition data; and
determining a color value of each of pixels constituting the image by comparing the foreground and background map of the target view with a foreground and background map of at least one reference view.

11. The image processing method of claim 10, wherein the depth transition data comprises information associated with a view at which a foreground-to-background transition or a background-to-foreground transmission occurs for each pixel.

12. The image processing method of claim 10, wherein the generating of the foreground and background map of the target view comprises generating the foreground and background map of the target view by comparing the target view with a transition view between a background and a foreground of each pixel included in the decoded depth transition data, and by determining whether each pixel corresponds to the foreground or the background at the target view.

13. The image processing method of claim 10, further comprising:
generating a foreground and background map of each of the at least one reference view based on depth information of each of the at least one reference view.

14. The image processing method of claim 13, wherein the generating of the foreground and background map of each of the at least one reference view comprises generating the foreground and background map of each of the at least one reference view by k-mean clustering depth information of each of the at least one reference view.

15. The image processing method of claim 13, wherein the generating of the foreground and background map of each of the at least one reference view comprises generating the foreground and background map of each of the at least one reference view by clustering depth information of each of the at least one reference view, and by performing histogram equalizing.

16. The image processing method of claim 10, wherein the determining comprises:
determining whether a foreground and background map value of a first pixel among a plurality of pixels constituting a target view image matches foreground and background map values of pixels having the same index as the first pixel within an image of each of the at least one reference view;
selecting, as a valid reference view, at least one reference view having the matching foreground and background map value as the determination result; and
determining a color value of the first pixel using an image of the valid reference view.

17. The image processing method of claim 16, wherein the determining of the color value of the first pixel comprises:
determining the color value of the first pixel by blending color values of at least two valid reference views when a number of valid reference views is at least two;
determining the color value of the first pixel by copying a color value of a single valid reference view when the number of valid reference views is one; and
determining the color value of the first pixel by performing hole filling using rendered color values of pixels adjacent to the first pixel when the number of valid reference views is zero.

18. A non-transitory computer-readable medium comprising a program for instructing a computer to perform the method of claim 10.
